(19) United States
(12) Patent Application Publication
(10) Pub. No.: US 2003/0217862 A1
(43) Pub. Date: Nov. 27, 2003

(54) Polymer insulator

(75) Inventor: Yasushi Ohkawa, Nagoya-shi (JP)

Correspondence Address: PARKHURST & WENDEL, L.L.P., 1421 PRINCE STREET, SUITE 210, ALEXANDRIA, VA, 22314-2805, US

(73) Assignee: NGK INSULATORS, LTD., Nagoya-shi (JP)

(21) Appl. No.: 10/393,393

(22) Filed: Mar. 21, 2003

(30) Foreign Application Priority Data
Mar. 27, 2002 (JP) P2002-087717

(51) Int. Cl. H01B 7/00

(52) U.S. Cl. 174/110 R; 174/212

(57) ABSTRACT

A polymer insulator includes (1) a core member; (2) an outer cover including a body portion provided around the core member and a plurality of sheds, wherein at least the shed on each end of the core member is thicker than other sheds, and (3) a securing metal fitting provided on each end of the core member.

### BACKGROUND OF THE INVENTION

1. Field of the Invention

The present invention relates to a polymer insulator comprising a core member, an outer cover provided around the core member, the outer cover including a body portion and sheds, and a securing metal fitting provided on each end of the core member.

2. Description of the Related Art

As shown in FIG. 1, a polymer insulator 51 comprising members described below has been heretofore known. The members include a core member 52, an outer cover 55 provided around the core member 52, the outer cover 55 including a body portion 53 and sheds 54, and a securing metal fitting 56 which is provided at each end of the core member 52. In such polymer insulator 51, especially in the polymer insulator for distribution lines showing relatively small size and withstand voltage of, for example, 6.6 kV, cost reduction of the polymer insulator 51 has been requested.

However, when the thicknesses of the sheds 54 were made to be thin, there have been quality problems described below. That is, while the polymer insulator 51 is being stocked, transported and handled, the sheds 54 are bent and deformed by the own weight of the polymer insulator 51, thus causing cracks at the root portions of the sheds 54. Another quality problem is electric punctures taking place in some of the sheds 54 during a tracking wheel test, which is one of the Canadian Electricity Association (CEA) standards.

### SUMMARY OF THE INVENTION

The first feature of the present invention is a polymer insulator comprising (1) a core member, (2) an outer cover including a body portion provided around the core member and a plurality of sheds, wherein at least the shed on each end of the core member is thicker than other sheds, and (3) a securing metal fitting provided on each end of the core member.

In the present invention, the term of “at least the shed on each end of the core member is thicker than other sheds” includes the case where two to three sheds from the respective ends are thick and the other sheds are thin, in addition to the case where the shed only on each end is thick.

The term of “the shed on each end of the core member is thicker than other sheds” means that, for example, the shed's thickness on each end of the core member is 6 mm in any portion, and the sheds' thickness at the positions other than each end is 3 mm in any portion. This meaning is valid in the case where the sheds are in uniform thickness even in the tip portions of the sheds and even in the root portions of the sheds.

In the case where the sheds are not in uniform thickness from the root portion to the tip portion, the term of “the shed on each end of the core member is thicker than other sheds” includes the following case.

For example, (1-1) the thickness of the root portion is 6 mm, the thickness of the tip portion is 3 mm and the distance between the root portion and the tip portion is 24 mm on each end of the core member, and (1-2) the thickness of the root portion is 3 mm, the thickness of the tip portion is 2 mm and the distance between the root portion and the tip portion is 24 mm on other than each end of the core member;

(2-1) the thickness of the root portion is 8 mm, the thickness of the tip portion is 4 mm and the distance between the root portion and the tip portion is 24 mm on each end of the core member, and (2-2) the thickness of the root portion is 3 mm, the thickness of the tip portion is 2 mm and the distance between the root portion and the tip portion is 24 mm on other than each end of the core member, and

(3-1) the thickness of the root portion is 8 mm, the thickness of the tip portion is 4 mm and the distance between the root portion and the tip portion is 38 mm on each end of the core member, and (3-2) the thickness of the root portion is 3 mm, the thickness of the tip portion is 2 mm and the distance between the root portion and the tip portion is 24 mm on other than each end of the core member.

### BRIEF DESCRIPTION OF THE DRAWINGS

FIG. 1 shows a configuration of a conventional polymer insulator, and partly includes a cross sectional diagram.

FIG. 2 shows a configuration of the polymer insulator according to the present invention, and partly includes a cross sectional diagram.

### DETAILED DESCRIPTION OF EMBODIMENTS

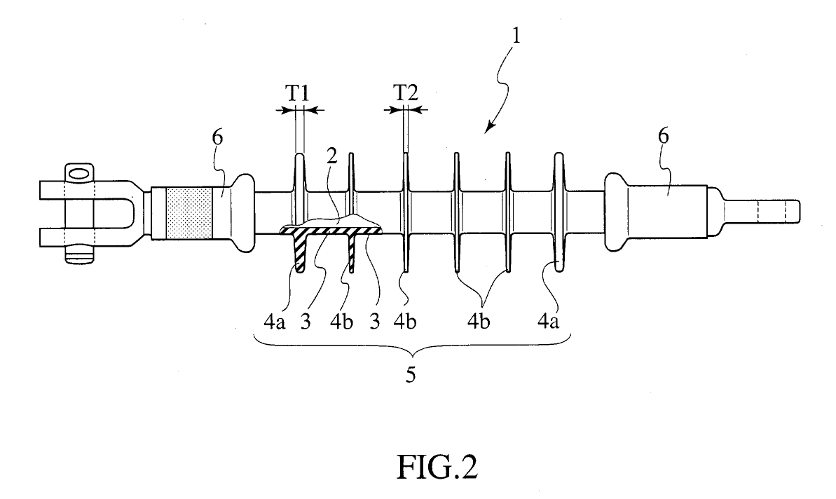

As shown in FIG. 2, a polymer insulator 1 is configured by a FRP core 2 as a core member, an outer cover 5 which is provided on the circumference of the FRP core 2 and includes a body portion 3 and sheds 4, and a securing metal fitting 6 which is provided on each end of the FRP core 2. Furthermore, the feature of the present invention is that, as shown in FIG. 2, the thickness of the shed 4a on each end among a plurality of sheds 4 is configured to be thicker than that of the sheds 4b at the positions other than the ends.

Specifically, in an embodiment shown in FIG. 2, the thickness (T1) of the shed 4a on each end is adjusted to be thicker than the thickness (T2) of the sheds 4b at the positions other than the ends. Moreover, it is preferable that (1) the thickness (T1) of the shed 4a on each end is so set that the sheds 4 will not be bent by the own weight of the polymer insulator 1 when the polymer insulator 1 is being stocked, transported or handled, or (2) the thickness (T1) of the shed 4a on each end is so set that electric punctures will not take place when the polymer insulator 1 is practically used. The increasing of the thickness (T1) of sheds 4a and the decreasing of the thickness (T2) of the sheds 4b make it possible to reduce raw materials for manufacturing of the sheds 4 without difficulty during the storage and practical use thereof. Usually the sheds having necessary thickness for preventing the polymer insulator 1 from being bent by the own weight do not generate electric punctures, and the sheds having necessary thickness for preventing electric puncture generation will not be bent by the own weight.

Here, “the sheds 4 are bent by the own weight of the polymer insulator 1” means the state where the sheds 4 bend, thereby the sheds can not support the polymer insulator 1. This occurs, as an example, when the polymer insulator 1 is placed on a platform with a plurality of the tips of the sheds 4 contacted to the surface of the platform at the same time, while the polymer insulator 1 is being stocked, transported, handled or the like. Also, “an electric puncture generates at a shed 4” means the state where the shed is in an electric pass-through situation, therefore the shed does not work as an insulator any more. This state is observed with the polymer insulator in a practical use or in an accelerated degradation test such as a tracking wheel test in a standard of LWIWG-02 of the CEA.

Note that, although two thicknesses in the sheds 4a on both ends are equal to each other in the example shown in FIG. 2, it is acceptable as far as the two sheds are in approximately the same shape, even if the thicknesses are a little different. Moreover in the similar way, all the thicknesses of the sheds 4b at the positions other than each end are not necessarily kept equal. The present invention is achieved as far as the thickness of the shed 4a on each end is configured to be thicker than the thickness of the sheds 4b at the position other than each end. In addition, though only the shed 4a on each end is configured to be thick in the example shown in FIG. 2, it is needless to say that the effect of the present invention is achieved, even if two to three respective sheds 4 from each end are configured to be thick and the other sheds 4 are configured to be thin.

In the polymer insulator 1 shown in FIG. 2, the shed 4a on each end can support the own weight of the polymer insulator 1. Thus, it is possible to remove quality problems such as bend and deformation in the sheds 4 by the own weight of the polymer insulator 1 or crack occurring at the root portions of the sheds 4, while the polymer insulator 1 is being stocked, transported or handled. In addition, since it is possible to make the sheds 4b at the positions other than each end to be thinner and the number of the sheds 4b is larger than the number of the sheds 4a, the amount of raw materials such as rubber used for the manufacturing of the outer cover 5 can be reduced.

### EXAMPLE

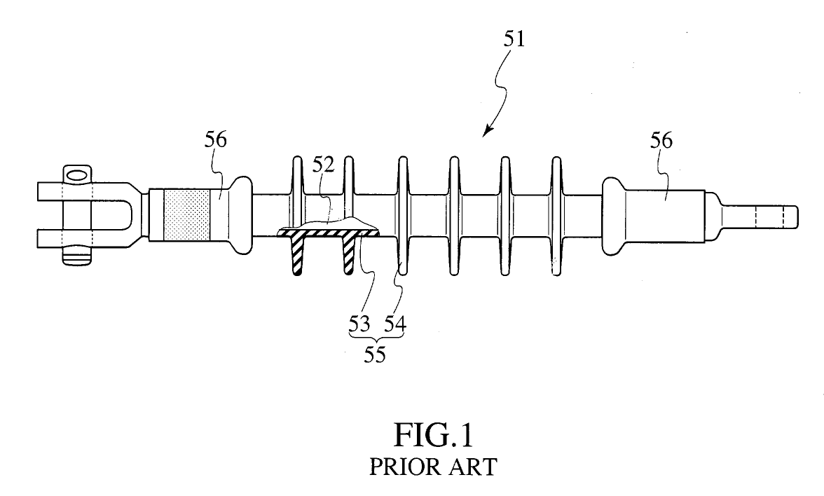

The polymer insulator according to the example of the present invention shown in FIG. 2 (Test numbers 2 and 3) and the polymer insulator according to the comparative example shown in FIG. 1 (Test numbers 1, 4 and 5) were prepared. Silicone rubber was used as the outer cover. The respective sheds' thicknesses (for example, T1 or T2 in FIG. 2) were prepared as shown in Table 1 below. On both of the polymer insulators prepared according to the example of the present invention and the comparative example, a tracking wheel test was conducted based on the standard LWIWG-02 “Line Post Composite Insulator for Overhead Distribution Lines” of the CEA. The test conditions applied to the polymer insulators were the voltage per unit leakage distance of 35 V/mm and 30,000 cycles thereof, thus the occurrence of punctures in the sheds and the securing metal fittings was investigated. The above term, 30,000 cycles is the standard value requested for the polymer insulator. The result is shown in Table 1 below.

TABLE 1

| SHED THICKNESS (mm) | |
|---|---|
| ENERGIZED SIDE | EARTH SIDE |

| | THE | THE | THE | THE | THE | THE | |
|---|---|---|---|---|---|---|---|
| TEST | FIRST | SECOND | THIRD | FOURTH | FIFTH | SIXTH | TRACKING WHEEL |
| NUMBER | SHED | SHED | SHED | SHED | SHED | SHED | TEST RESULTS |
| 1 | 6 | 6 | 6 | 6 | 6 | 6 | NO PUNCTURES |
| | | | | | | | DURING 30,000 |
| | | | | | | | CYCLES |
| 2 | 6 | 3 | 3 | 3 | 3 | 6 | NO PUNCTURES |
| | | | | | | | DURING 30,000 |
| | | | | | | | CYCLES |
| 3 | 6 | 3 | 3 | 3 | 3 | 6 | NO PUNCTURES |
| | | | | | | | DURING 30,000 |
| | | | | | | | CYCLES |
| 4 | 3 | 3 | 3 | 3 | 3 | 3 | PUNCTURES |
| | | | | | | | WITH THE FIRST SHED |
| | | | | | | | AT 19,000^{TH} CYCLE |
| 5 | 3 | 3 | 3 | 3 | 3 | 3 | PUNCTURES |
| | | | | | | | WITH THE FIRST SHED |
| | | | | | | | AT 28,000^{TH} CYCLE |

As shown in Table 1, among the comparative examples, only the test number 1 passed the standard value. Here, the standard value was “no punctures occurred during 30,000 cycles.” On the other hand, regarding the examples of the present invention of both of the test numbers 2 and 3, it is sufficient that only the shed on each end (the first and sixth sheds) is 6 mm thick, and the sheds at the positions other than each end (the second through fifth sheds) are 3 mm thick. That is, the rubber amount used can be reduced without degradation in quality and performances.

Based on the explanation above, it is clear that, according to the present invention, the reduction in the amount of materials used for the manufacturing of the outer cover is possible without degradation in quality and performances, because the shed thickness at least on each end of the core member is thick. Meanwhile, it is preferable that at least the shed on each end has enough thickness not to be bent by the own weight. Moreover, it is further preferable that at least the shed on each end has appropriate thickness to prevent electric puncture.

Although the present invention has been explained with specific examples and numeral values, it is of course apparent to those skilled in the art that various changes and modifications thereof are possible without departing from the broad spirit and aspect of the present invention as defined in the appended claims.

### CROSS REFERENCE TO RELATED APPLICATIONS

This application is based upon and claims the benefit of priority from prior Japanese Patent Application P2002-087717 filed on Mar. 27, 2002; the entire contents of which are incorporated by reference herein.

What is claimed is:

1. A polymer insulator comprising:
a core member;
an outer cover including a body portion provided around the core member and a plurality of sheds, wherein at least the shed on each end of the core member is thicker than other sheds; and
a securing metal fitting provided on each end of the core member.

2. The polymer insulator according to claim 1, wherein at least the shed on each end is thick enough to prevent the sheds from being bent by own weight of the polymer insulator, while the polymer insulator is being stocked, transported and handled.

3. The polymer insulator according to claim 1, wherein at least the shed on each end is thick enough not to cause electric puncture while the polymer insulator is being practically used.
